(19) United States
(12) Patent Application Publication
(10) Pub. No.: US 2026/0214751 A1
(43) Pub. Date: Jul. 23, 2026

(54) CONTROL DEVICE, CONTROL METHOD AND CONTROL PROGRAM

(71) Applicant: NHK SPRING CO., LTD., Yokohama-shi, Kanagawa (JP)

(72) Inventors: Marino SATO, Yokohama-shi, Kanagawa (JP); Jun TOKUSHIGE, Yokohama-shi, Kanagawa (JP); Yuto TSUDA, Yokohama-shi, Kanagawa (JP)

(21) Appl. No.: 19/138,983

(22) PCT Filed: Dec. 5, 2023
(86) PCT No.: PCT/JP2023/043514

§ 371 Date: Jun. 13, 2025

(30) Foreign Application Priority Data
Dec. 14, 2022 (JP) 2022-199830

(51) Int. Cl. H05B 1/02; H05B 3/14; H05B 3/20

(52) U.S. Cl. CPC H05B 1/0238; H05B 3/145; H05B 3/20

(57) ABSTRACT

A heater ECU serving as an example of a control device has: a control section that, even while control of a heater is stopped, controls electric power supplied to the heater such that a duty ratio of a voltage value and a current value of the heater becomes higher than 0%; and a deriving section deriving a resistance value of the heater on the basis of the voltage value and the current value of the heater.

### TECHNICAL FIELD

The present disclosure relates to a control device, a control method and a control program.

### BACKGROUND ART

There has conventionally been disclosed a technique of computing the resistance value of a heater from the voltage value and current value of the heater, and sensing an abnormality of the heater on the basis of the resistance value. For example, Japanese Patent Application Laid-Open (JP-A) No. 2002-215246 discloses a temperature control method of a heater formed from a resistance wire. In this temperature control method, the voltage value applied to the heater and the current value flowing to the heater are measured, and the heater is made to become a predetermined temperature due to the electric power supplied to the heater being adjusted on the basis of the measured voltage value and current value.

### SUMMARY OF INVENTION

### Technical Problem

In a case in which a heater control device is stopping control of a heater, when the output of the electric power to the heater stops, the resistance value of the heater cannot be measured during the time period in which the outputting of electric power is stopped, and therefore, abnormalities of the heater cannot be sensed.

The present disclosure was made in view of the above-described point, and provides a control device, a control method and a control program that can sense an abnormality of a heater even while control of the heater is stopped.

### Solution to Problem

A control device of a first aspect includes: a control section that, even while control of a heater is stopped, controls electric power supplied to the heater such that a duty ratio of a voltage value and a current value of the heater becomes higher than 0%; and a deriving section deriving a resistance value of the heater on the basis of the voltage value and the current value.

In accordance with the control device of the first aspect, even while control of a heater is stopped, an abnormality of the heater can be sensed.

A control device of a second aspect is the control device of the first aspect, wherein the heater is structured to include electrically-conductive, fine carbon structures.

A control device of a third aspect is the control device of the second aspect, wherein the heater is a planar heater structured to include carbon nanotubes.

In accordance with the control device of the third aspect, not only can the entirety be heated uniformly, but also, heating is rapid, and therefore, a heater having a good usage feel can be provided.

A control device of a fourth aspect is the control device of any one of the first aspect through the third aspect that further includes: an acquiring section acquiring an environmental temperature of a periphery of the heater; and a stopping section stopping control of the heater in a case in which the environmental temperature exceeds a set temperature that is set in advance.

In accordance with the fourth aspect, the environmental temperature can be prevented from rising excessively.

A control device of a fifth aspect is the control device of any one of the first aspect through the fourth aspect wherein, in a case in which an engine of a vehicle that has the heater is activated, even if control of the heater is stopped, the control section controls electric power supplied to the heater such that the duty ratio of the voltage value and the current value of the heater becomes higher than 0%, and, in a case in which the engine is stopped and control of the heater is stopped, the control section effects control to cancel supply of electric power to the heater.

In accordance with the control device of the fifth aspect, in a case in which the engine of the vehicle is activated, an abnormality of the heater can be sensed even if control of the heater is stopped.

A sixth aspect is a control method in which a computer executes processing of: even while control of a heater is stopped, controlling electric power supplied to the heater such that a duty ratio of a voltage value and a current value of the heater becomes higher than 0%; and deriving a resistance value of the heater on the basis of the voltage value and the current value.

A seventh aspect is a control program that causes a computer to execute processings of: even while control of a heater is stopped, controlling electric power supplied to the heater such that a duty ratio of a voltage value and a current value of the heater becomes higher than 0%; and deriving a resistance value of the heater on the basis of the voltage value and the current value.

### Advantageous Effects of Invention

In accordance with the present disclosure, an abnormality of a heater can be sensed even while control of the heater is stopped.

### BRIEF DESCRIPTION OF DRAWINGS

FIG. 1 is a block drawing illustrating an example of hardware structures of a vehicle relating to an embodiment.

FIG. 2 is a block drawing illustrating an example of functional structures of a heater ECU relating to the embodiment.

FIG. 3 is a flowchart illustrating an example of control processing relating to the embodiment.

### DESCRIPTION OF EMBODIMENTS

This application is based on Japanese Patent Application No. 2022-199830 filed on Dec. 14, 2022 in Japan, the contents of which form a portion of the contents of the present application.

Further, the present disclosure can be can be understood more completely from the following detailed description. A broader scope of application of the present application will become more clear from the following detailed description. However, this detailed description and the specific actual examples are preferred embodiments of the present disclosure and are put forth only for the purpose of explanation. From this detailed description, various changes and modifications within the spirit and scope of the present disclosure will be clear to those skilled in the art.
Among the disclosed modifications and alternatives, which the present applicant does not intend to present publicly, of the described embodiments, structures that may not be expressly included in the Claims also are part of the invention under the doctrine of equivalents.

Examples of embodiments of the present disclosure are described hereinafter with reference to the drawings.

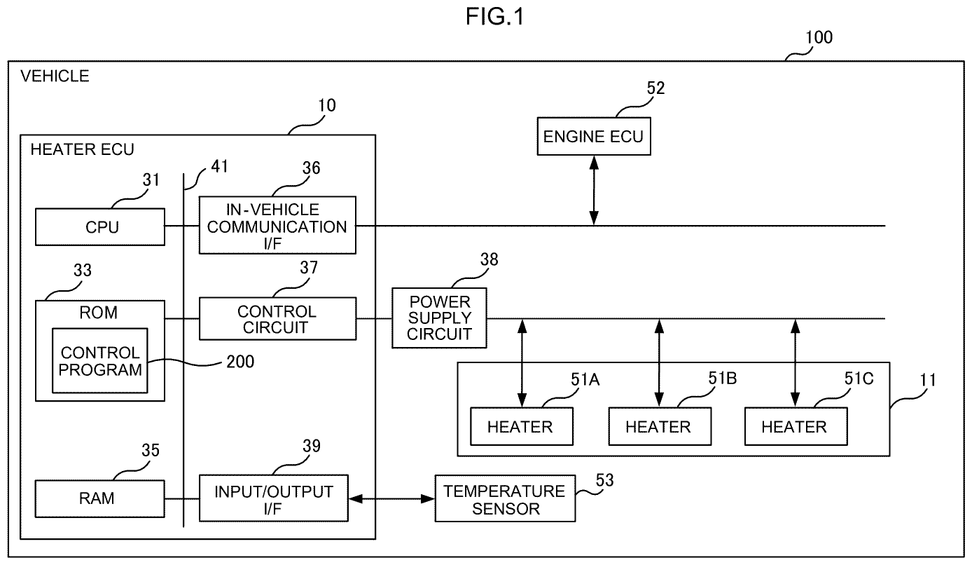

FIG. 1 illustrates hardware structures of a vehicle 100 that includes a heater ECU (Electronic Control Unit) 10. As illustrated in FIG. 1, the control device relating to a present embodiment can be included in the vehicle 100. The vehicle 100 may be structured to include the heater ECU 10 serving as an example of the control device, a vehicle seat 11, a power supply circuit 38, heaters 51, an engine ECU 52 and a temperature sensor 53.

The vehicle seat 11 may be structured to include the plural heaters 51 at the interior thereof. Specifically, the heaters 51 may include heater 51A, heater 51B and heater 51C. The heater 51A, the heater 51B and the heater 51C are disposed at respective portions of the vehicle seat 11, and function to warm the body of the passenger. The heaters 51 may be structured to include electrically-conductive, fine carbon structures. Specifically, the heaters 51 may be a planar heater structured to include carbon nanotubes. However, the heaters 51 are not limited to this example. For example, the heaters 51 may be structured to include carbon picotubes.

The power supply circuit 38 may be a circuit that supplies electric power to the heaters 51 on the basis of instructions from a control circuit 37.

The respective heaters 51 are connected to the heater ECU 10 via the power supply circuit 38.

The engine ECU 52 is an ECU that controls the engine of the vehicle 100. The engine ECU 52 can control activation and stoppage of the engine.

The temperature sensor 53 is a sensor for detecting the environmental temperature of the periphery of the heaters 51. The temperature sensor 53 may be connected to the heater ECU 10. The temperature sensor 53 can be installed in the heaters 51 or in the vehicle seat 11.

Note that the respective numbers of the heater ECU 10, the vehicle seat 11, the heaters 51 and the temperature sensor 53 that are included in the vehicle 100 are not limited to the example of FIG. 1. For example, two or more of each of the heater ECU 10 and the temperature sensor 53 may be included, or the vehicle seat 11 may be structured by an arbitrary number of the heaters 51. Further, the vehicle 100 of the present embodiment may have plural vehicle seats 11. In this case, the respective heaters 51 may be controlled by the single heater ECU 10, or the respective heaters 51 may be controlled by the heater ECU 10 that is provided for each of the vehicle seats 11.

The heater ECU 10 functions to control the respective heaters 51 that the vehicle seat 11 has. As illustrated in FIG. 1, the heater ECU 10 may have a CPU (Central Processing Unit) 31, a ROM (Read Only Memory) 33, a RAM (Random Access Memory) 35, an in-vehicle communication I/F (Interface) 36, the control circuit 37 and an input/output I/F 39. Note that the CPU 31 corresponds to the computer relating to the present embodiment.

The CPU 31, the ROM 33, the RAM 35, the in-vehicle communication I/F 36, the control circuit 37 and the input/output I/F 39 may be connected so as to be able to communicate with one another via internal bus 41.

The CPU 31 is a central computing processing unit, and may execute various programs and control respective structures. Namely, the CPU 31 can read-out a program from the ROM 33 and execute the program by using the RAM 35 as a workspace. The CPU 31 can carry out control of the above-described respective structures, and various computing processings, in accordance with the program stored in the ROM 33.

The ROM 33 may store various programs, including the operating system, and various data. A control program 200 for executing control processing that is described later may be stored in the ROM 33. Note that a recording medium such as an HDD (Hard Disk Drive) or an SSD (Solid State Drive) may be provided in place of or in addition to the ROM 33.

The RAM 35 can temporarily store programs and data as a workspace.

The in-vehicle communication I/F 36 may be an interface for connection with the engine ECU 52.

The power supply circuit 38 is connected to the control circuit 37. This control circuit 37 can control the power supply circuit 38.

The input/output I/F 39 may be an interface for connection with the temperature sensor 53.

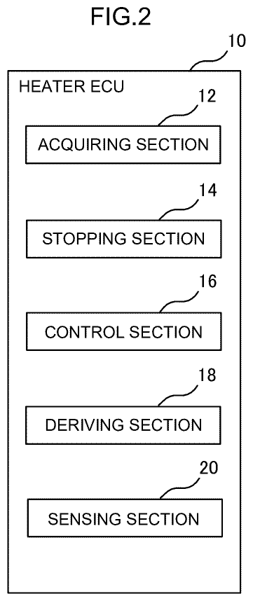

Functional structures of the heater ECU 10 relating to the present embodiment are described next with reference to FIG. 2. As illustrated in FIG. 2, due to the CPU 31 executing the control program 200 that is stored in the ROM 33, the heater ECU 10 of the present embodiment can function as an acquiring section 12, a stopping section 14, a control section 16, a deriving section 18 and a sensing section 20.

The acquiring section 12 has the function of acquiring the environmental temperature of the periphery of the heaters 51. Specifically, the acquiring section 12 can, via the input/output I/F 39, acquire temperature information measured by the temperature sensor 53.

The stopping section 14 has the function of stopping control of the heaters 51, in a case in which the environmental temperature exceeds a set temperature that is set in advance. The set temperature may be set in advance by the owner or the manufacturer of the vehicle 100. Note that the stopping section 14 continues control of the heater 51 whose environmental temperature is less than or equal to the set temperature.

The control section 16 has the function of, even in a case in which the stopping section 14 is stopping control of the heater 51, controlling the electric power supplied to that heater 51 such that the duty ratio of the voltage value and the current value of that heater 51 becomes higher than 0%. Specifically, in a case in which the stopping section 14 is stopping control of the heater 51, the control section 16 can output an instruction to the control circuit 37 such that there is a small duty ratio (e.g., 1%) of the voltage value and the current value as compared with a case in which the stopping section 14 is not stopping control of the heater 51. Hereinafter, the electric power that the power supply circuit 38 supplies to the heater 51 in a case in which the stopping section 14 is stopping control of the heater 51 is called a minute electric power. The minute electric power is the electric power that can ensure a time period in which the deriving section 18 that is described later can acquire the voltage value and the current value of the heater 51. Further, the electric power that the power supply circuit 38 supplies to the heater 51 in a case in which the stopping section 14 is not stopping control of the heater 51 is called the usual electric power. Moreover, the upper limit value of the duty ratio is a current of an extent that the heater 51 does not work, and can be set arbitrarily provided that it is in a range in which the resistance can be computed from the voltage and current of times of energization, and can be set to be, for example, less than or equal to 10%.

In the present embodiment, the control section 16 acquires, from the engine ECU 52, engine information expressing whether or not the engine of the vehicle 100 is activated. In a case in which the engine of the vehicle 100 is activated, even if the stopping section 14 is stopping control of the heater 51, the control section 16 outputs an instruction to the control circuit 37 to output the minute electric power to that heater 51. Further, in a case in which the engine of the vehicle 100 is stopped and the stopping section 14 is stopping control of the heater 51, the control section 16 of the present embodiment outputs an instruction to the control circuit 37 to cancel the supply of electric power to that heater 51.

Note that, regardless of whether or not the engine of the vehicle 100 is activated, in a case in which the stopping section 14 is stopping control of the heater 51, the control section 16 may output an instruction to the control circuit 37 to output the minute electric power to that heater 51.

The deriving section 18 has the function of deriving the resistance value of the heater 51 on the basis of the voltage value and the current value of the heater 51. The voltage value and the current value of the heater 51 are values that fluctuate due to on and off switching in accordance with PWM (Pulse Width Modulation) control. Specifically, the deriving section 18 can derive the resistance value of the heater 51 by dividing the voltage value of the heater 51 acquired via the control circuit 37 by the current value of the heater 51 acquired via the control circuit 37.

The sensing section 20 senses abnormalities of the heater 51. Specifically, the sensing section 20 can sense an abnormality of the heater 51 in a case in which the resistance value derived by the deriving section 18 falls outside of a predetermined range. The sensing section 20 can output an instruction to the control circuit 37 to stop the supply of power to the heater 51 at which an abnormality has been sensed. In the present embodiment, a range that is from a value, which less by a fixed proportion (e.g., 1%) than a predetermined resistance value, to a value, which is greater by the fixed proportion than the predetermined resistance value, is used as the aforementioned predetermined range. Further, in the present embodiment, the resistance value that was derived by the deriving section 18 the previous time is used as the aforementioned predetermined resistance value. However, the present disclosure is not limited to the above-described example. For example, a value that has been determined in advance by the owner or the manufacturer of the vehicle 100, or the resistance value in a case in which at least one of the voltage value and the current value of the heater 51 is the upper limit value of the rating, may be used as the aforementioned predetermined resistance value.

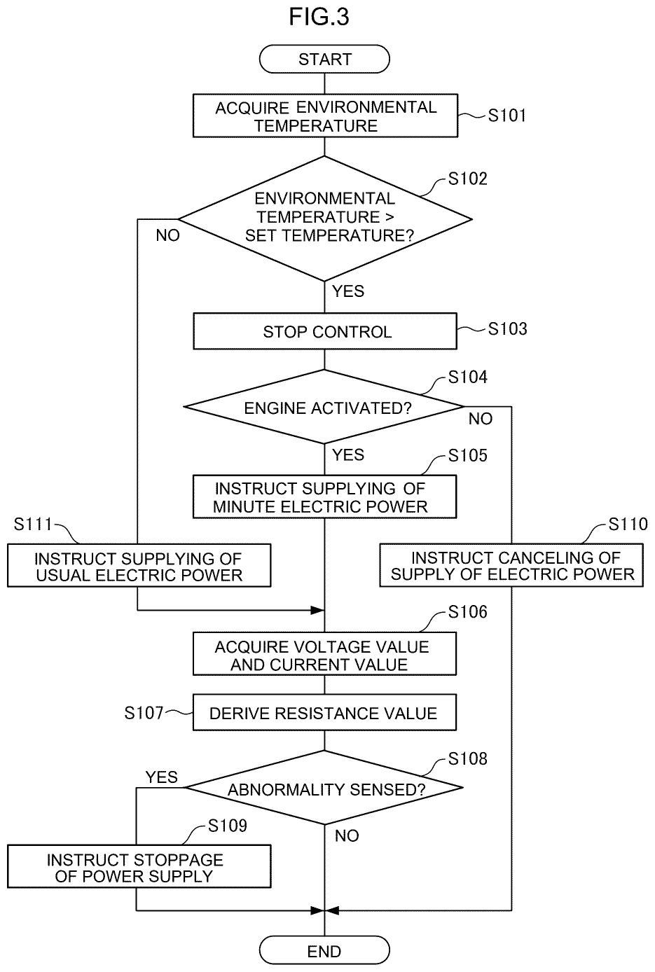

An example of operation of the heater ECU 10 relating to the present embodiment is described next. The control processing of the heater 51 illustrated in FIG. 3 is executed at the vehicle 100. The respective processings at the heater ECU 10 can be executed by the CPU 31 functioning as the acquiring section 12, the stopping section 14, the control section 16, the deriving section 18 and the sensing section 20. Note that the control processing corresponds to the processing that the CPU 31, which serves as a computer, executes by the control method relating to the present embodiment.

In step S101 of FIG. 3, the CPU 31 acquires the environmental temperature of the periphery of the heater 51. Specifically, via the input/output I/F 39, the CPU 31 acquires the temperature information measured by the temperature sensor 53.

In step S102, the CPU 31 judges whether or not the environmental temperature acquired in step S101 has exceeded a set temperature. If the environmental temperature has exceeded a set temperature (step S102: YES), the CPU 31 moves on to step S103.

In step S103, the CPU 31 stops control of the heater 51 at which the environmental temperature has exceeded a set temperature.

In step S104, the CPU 31 judges whether or not the engine of the vehicle 100 is activated. Specifically, the CPU 31 judges whether or not the engine information acquired from the engine ECU 52 is information expressing that the engine is activated. If the engine of the vehicle 100 is activated (step S104: YES), the CPU 31 moves on to step S105.

In step S105, the CPU 31 outputs an instruction to the control circuit 37 to supply the minute electric power to the heater 51.

In step S106, the CPU 31 acquires the voltage value and the current value of the heater 51. Specifically, the CPU 31 acquires, from the control circuit 37, the voltage value and the current value that fluctuate due to on and off switching in accordance with PWM control.

In step S107, the CPU 31 derives the resistance value of the heater 51 by dividing the voltage value acquired in step S106 by the current value acquired in step S106.

In step S108, the CPU 31 judges whether or not an abnormality of the heater 51 has been sensed. Specifically, the CPU 31 judges whether or not the resistance value derived in step S107 falls outside of a predetermined range. If an abnormality of the heater 51 has been sensed (step S108: YES), the CPU 31 moves on to step S109. On the other hand, if an abnormality of the heater 51 has not been sensed (step S108: NO), the CPU 31 ends the control processing.

In step S109, the CPU 31 outputs an instruction to the control circuit 37 to stop the power supply of the heater 51. Then, the control processing ends.

Returning to step S104, if the engine of the vehicle 100 is not activated (step S104: NO), the CPU 31 moves on to step S110.

In step S110, the CPU 31 outputs an instruction to the control circuit 37 to cancel the supply of electric power to the heater 51. Then, the control processing ends.

Returning to step S102, if the environmental temperature is less than or equal to the set temperature (step S102: NO), the CPU 31 moves on to step S111.

In step S111, the CPU 31 outputs an instruction to the control circuit 37 to supply the usual electric power, and moves on to step S106.

As described above, even when the stopping section 14 is stopping control of the heater 51, the control section 16 of the heater ECU 10 relating to the present embodiment controls the electric power supplied to that heater 51 such that the duty ratio of the voltage value and the current value of the heater 51 becomes higher than 0%. Further, the deriving section 18 of the heater ECU 10 derives the resistance value of the heater 51 on the basis of the voltage value and the current value of the heater 51.

In accordance with the present embodiment, an abnormality of the heater 51 can be sensed even in a case in which control of that heater 51 is stopped. Further, in a case in which the heater ECU 10 is controlling plural heaters 51, the effects due to the wiring resistance from the control substrate to the heaters 51 change depending on the number of the heaters 51 that are being controlled (i.e., the amount of current). In this case, there is the problem that, if output of electric power to the heater 51 whose control is stopped by the heater ECU 10 is stopped, the results of measurement of the resistance values of the other heaters 51 fluctuate. In accordance with the present embodiment, the resistance value of the heater 51 can be measured accurately without being affected by the wiring resistance.

Further, the heater 51 relating to the present embodiment is structured to include electrically-conductive, fine carbon structures. As an example, the heater 51 relating to the present embodiment is a planar heater structured to include carbon nanotubes. In accordance with the present embodiment, there can be provided a heater that has a good usage feel.

Further, the acquiring section 12 of the heater ECU 10 relating to the present embodiment acquires the environmental temperature of the periphery of the heater 51. Then, the stopping section 14 of the heater ECU 10 stops control of the heater 51 in a case in which the environmental temperature has exceeded a set temperature that has been set in advance. In accordance with the present embodiment, the environmental temperature can be prevented from rising excessively.

Further, in a case in which the engine of the vehicle 100 is activated, even if the stopping section 14 is stopping control of the heater 51, the control section 16 relating to the present embodiment controls the electric power that is supplied to the heater 51 such that the duty ratio of the voltage value and the current value of the heater 51 becomes higher than 0%. Further, in a case in which the engine is stopped, and the stopping section 14 is stopping control of the heater 51, the control section 16 carries out control to cancel the supply of electric power to the heater 51. In accordance with the present embodiment, in a case in which the engine of the vehicle is activated, an abnormality of a heater can be sensed even if control of that heater is stopped.

Note that the present embodiment describes, as an example, a heater that is structured to include electrically-conductive, fine carbon structures. However, the present disclosure can also be applied to the measuring of the resistance value of a nichrome wire that is a heating wire.

Further, although the present embodiment describes a vehicle seat as an example, the heater ECU 10 can also be applied to other products that can use a heater that includes electrically-conductive, fine carbon structures, such as clothes and seats other than those of a vehicle.

Further, in the present embodiment, the sensing section 20 of the heater ECU 10 senses an abnormality of the heater 51 in a case in which the resistance value of the heater 51 falls outside of a predetermined range. However, the present disclosure is not limited to this example. A sensing device other than the heater ECU 10 may sense an abnormality of the heater 51 on the basis of the resistance value of the heater 51. In this case, for example, the deriving section 18 of the heater ECU 10 outputs the derived resistance value of the heater 51 to the sensing device. Then, the sensing device senses an abnormality of the heater 51 on the basis of the outputted resistance value of the heater 51.

The control processing, which is executed by the CPU reading-in software (a program) in the above-described embodiment, may be executed by any of various types of processors other than a CPU. Examples of processors in this case include PLDs (Programmable Logic Devices) whose circuit structure can be changed after production such as FPGAs (Field-Programmable Gate Arrays), and dedicated electrical circuits that are processors having circuit structures that are designed for the sole purpose of executing specific processings such as ASICs (Application Specific Integrated Circuits). Further, the control processing may be executed by one of these various types of processors, or may be executed by a combination of two or more of the same type or different types of processors (e.g., plural FPGAs, or a combination of a CPU and an FPGA). Further, the hardware structures of these various types of processors are, more specifically, electrical circuits that combine circuit elements such as semiconductor elements.

Further, the above embodiment describes an aspect in which the control program 200 is stored in advance (is installed) in a storage device, but the present disclosure is not limited to this. The program may be provided in a form of being recorded on a recording medium such as a CD-ROM, a DVD-ROM (Digital Versatile Disc Read Only Memory), or a USB (Universal Serial Bus) memory. Further, the program may be in a form of being downloaded over a network from an external device.

All publications including periodicals, patent applications and patents that are cited in the present specification are incorporated by reference herein to the same extent as if each publication were to be individually and specifically incorporated by reference or all of the contents thereof were to be described herein.

The use of nouns and similar instructions that are used in relation to the description of the present disclosure (in relation to the following Claims in particular) are to be interpreted as covering both singular and plural forms, provided that such is not specified otherwise in the present specification nor is in obvious contradiction to the context. The words and phrases “equipped with”, “having”, “including” and “incorporating” are to be interpreted as open-ended terms (i.e., meaning “including . . . but not limited thereto”), unless otherwise specified. The stating of the numerical value ranges in the present specification is merely intended to function as shorthand notation for individually mentioning the corresponding respective values within the range, and each value is incorporated into the present specification as if individually exemplified in the specification, unless otherwise noted in the present specification. All of the methods described in the present specification can be carried out in any appropriate order, provided that such is not specified otherwise in the present specification nor is in obvious contradiction to the context. All examples and exemplifying expressions (e.g., “and the like”) that are used in the present specification are, unless otherwise stated, merely intended to better explain the present disclosure and do not limit the scope of the present disclosure. All expressions in the specification as well are not to be interpreted as meaning that elements that are not recited in the Claims are indispensable to implementation of the present disclosure.

The present specification includes best forms known by the present inventors for implementing the present disclosure, and preferred embodiments of the present disclosure are described. Modifications of these preferred embodiments will be clear to those skilled in the art upon reading the above description. The present inventors anticipate that experts will appropriately apply such modifications, and intend that the present disclosure will be implemented by methods other than those specifically described in the present specification. Accordingly, the present disclosure includes all alterations and equivalents of the contents recited in the Claims appended to the present specification as permitted by governing law. Moreover, all combinations of the above-described elements in all of the modifications also are incorporated into the present disclosure, provided that such is not otherwise specified in the present specification nor is in obvious contradiction to the context.

1. A control device comprising a processor, the processor being configured to:
even while control of a heater is stopped, control electric power supplied to the heater such that a duty ratio of a voltage value and a current value of the heater becomes higher than 0%; and
derive a resistance value of the heater based on the voltage value and the current value.

2. The control device of claim 1, wherein the heater is structured to include electrically-conductive, fine carbon structures.

3. The control device of claim 1, wherein the heater is a planar heater structured to include carbon nanotubes.

4. The control device of claim 1, wherein the processor is configured to:
acquire an environmental temperature of a periphery of the heater; and
stop control of the heater in a case in which the environmental temperature exceeds a set temperature that is set in advance.

5. The control device of claim 1, wherein, in a case in which an engine of a vehicle that has the heater is activated, even if control of the heater is stopped, the processor controls electric power supplied to the heater such that the duty ratio of the voltage value and the current value of the heater becomes higher than 0%, and, in a case in which the engine is stopped and control of the heater is stopped, the processor effects control to cancel supply of electric power to the heater.

6. A control method comprising, by a computer:
even while control of a heater is stopped, controlling electric power supplied to the heater such that a duty ratio of a voltage value and a current value of the heater becomes higher than 0%; and
deriving a resistance value of the heater based on the voltage value and the current value.

7. A non-transitory computer-readable medium storing a control program that is executable by a computer to perform processing of:
even while control of a heater is stopped, controlling electric power supplied to the heater such that a duty ratio of a voltage value and a current value of the heater becomes higher than 0%; and
deriving a resistance value of the heater based on the voltage value and the current value.
